(19) United States
(12) Patent Application Publication
(10) Pub. No.: US 2021/0115330 A1
(43) Pub. Date: Apr. 22, 2021

(54) FUNCTIONALIZED SEMICONDUCTOR NANOPARTICLES AND METHOD FOR THE MANUFACTURE THEREOF

(71) Applicants: UNIVERSITEIT VAN AMSTERDAM, Amsterdam (NL); UNIVERSITEIT TWENTE, Enschede (NL)

(72) Inventors: Hui NIE, Enschede (NL); Katerina NEWELL, Amsterdam (NL); Jos Marie Johannes PAULUSSE, Enschede (NL)

(73) Assignees: UNIVERSITEIT TWENTE, Enschede (NL); UNIVERSITEIT VAN AMSTERDAM, Amsterdam (NL)

(21) Appl. No.: 17/052,031

(22) PCT Filed: May 1, 2019
(86) PCT No.: PCT/EP2019/061138

§ 371 Date: Oct. 30, 2020

(30) Foreign Application Priority Data
May 2, 2018 (EP) 18170318.2

(51) Int. Cl. C09K 11/66; C09K 11/59; C09K 11/02; C01B 33/06; C01G 17/00

(52) U.S. Cl. CPC C09K 11/66; C09K 11/59; B82Y 20/00; C01B 33/06; C01G 17/00; C09K 11/02

(57) ABSTRACT

Method for manufacturing fluoro(hydro)carbon-substituted silicon or germanium quantum dots which comprises the steps of:—reacting a Zintl salt or intermetallic compound of post-transition metals or metalloids of silicon or germanium with a halogen-containing oxidizing agent to form halide-terminated silicon or germanium quantum dots,—reacting the halide-terminated silicon or germanium quantum dots with a fluoro(hydro)carbon agent selected from the group of metal-fluoro (hydro)carbon compounds of the formula MRq, wherein M is a metal selected from Group 1, 2, 4, 11, 12, 13, or 14 of the periodic table of elements, q is an integer which corresponds to the valence of the metal, and R is CFnHm-fluoro/hydro-carbon, wherein n is 1 or 2, m is 0 or 1, and the total of n and m is 2, wherein each R may be the same or different, metal-fluoro (hydro)carbon halide compounds of the formula NQaRp wherein N is a metal selected from Group 1, 2, 4, 11, 12, 13, or 14 of the periodic table of elements, Q is a halogen selected from F, Cl, Br, or I, wherein each Q may be the same or different, a and p are integers in the range of 1-3, and the total of a and p corresponds to the valence of the metal, and R is as defined above, and metal-fluoro (hydro)carbon compounds of the formula CuR2Li, wherein R is as defined above, to form fluoro(hydro)carbon-substituted silicon or germanium quantum dots. The method makes it possible to obtain quantum dots with a tailored emission spectrum with high quality in a stable process. The particles obtained by this process are also claimed.

The present invention pertains to functionalized nanoparticles and a method for manufacturing them.

Quantum dots (QD) are semiconductor based nanoparticles which display a size dependent light emission at specific frequencies upon excitation by electricity or light. By changing the physical or chemical properties of the quantum dots, in particular their size, shape, and/or composition, or surface capping, the frequency of the emitted light can be tuned. Quantum dots have potential in a number of applications including LEDs, displays, medical imaging, transistors, solar cells, as well as diode lasers, second-harmonic generation and quantum computing. Silicon quantum dots are of particular interest in view of the wide availability of silicon, its non-toxic character, and their optoelectronic properties. Germanium quantum dots are likewise of interest as well due to their attractive optoelectronic properties.

One way of tuning the properties of quantum dots, including the frequency of the emitted light, is by modifying the properties of the surface of the particles, e.g., by grafting specific organic or inorganic groups onto the surface. This process may also be indicated as passivation.

Numerous organic passivation reagents and methods have been reported, such as hydrosilylation of H-terminated silicon quantum dots with alkenes, and nucleophilic substitution of halogen-terminated silicon quantum dots with Grignard reagents or metal alkyl reagents. Through these processes, in most cases, hydrocarbon-capped silicon quantum dots are obtained.

It has been found that there is need in the art for a method which allows further tuning of the emission spectrum of silicon quantum dots. In particular, it has been found that there is need for a method which enables a shift in the red-direction of the emitted light. For example, most silicon quantum dots emit light in the blue range of the spectrum, that is, the emission spectrum has a peak at about 450 nm. To bring quantum dots to their full potential it is necessary to have quantum dots which emit light in other parts of the spectrum. Among others, there is need in the art for quantum dots which emit light in the green part of the spectrum, i.e. in the range of 495-570 nm.

The present invention provides a method which allows the manufacture of quantum dots with a tailored emission spectrum. In particular, the invention provides a method which makes it possible to obtain quantum dots with an emission spectrum which has shows a shift in the red direction as compared to blue quantum dots. In one embodiment the present invention provides a method which allows the manufacture of quantum dots with an emission spectrum which shows a shift in the red-direction of 20-80 nm as compared to quantum dots substituted with hydrocarbon substituents. In one embodiment, the invention provides a method for manufacturing quantum dots with a peak in their emission spectrum in the range of 495-570 nm, i.e. in the green range. The invention also pertains to quantum dots obtained by the claimed method.

In a first aspect the present invention pertains to a method for manufacturing fluoro(hydro)carbon-substituted silicon or germanium quantum dots which comprises the steps of:
reacting a Zintl salt or intermetallic compound of post-transition metals or metalloids of silicon or germanium with a halogen-containing oxidizing agent to form halide-terminated silicon or germanium quantum dots,
reacting the halide-terminated silicon or germanium quantum dots with a fluoro(hydro)carbon agent selected from the group of
   metal-fluoro(hydro)carbon compounds of the formula MR_{q}, wherein M is a metal selected from Group 1, 2, 4, 11, 12, 13, or 14 of the periodic table of elements, q is an integer which corresponds to the valence of the metal, and R is CFnHm-fluoro/hydro-carbon, wherein n is 1 or 2, m is 0 or 1, and the total of n and m is 2, wherein each R may be the same or different,
   metal-fluoro(hydro)carbon halide compounds of the formula NQₐRₚ wherein N is a metal selected from Group 1, 2, 4, 11, 12, 13, or 14 of the periodic table of elements, Q is a halogen selected from F, Cl, Br, or I, wherein each Q may be the same or different, a and p are integers in the range of 1-3, and the total of a and p corresponds to the valence of the metal, and R is as defined above, and
   metal-fluoro(hydro)carbon compounds of the formula CuR₂Li, wherein R is as defined above,
   to form fluoro(hydro)carbon-substituted silicon or germanium quantum dots.

In a second aspect the present invention pertains silicon or germanium quantum dots derived from a Zintl salt or intermetallic compound of post-transition metals or metalloids of silicon or germanium comprising CFnHm-fluoro/hydrocarbon groups bonded directly to the silicon or germanium of the particle.

It has been found that the specific combination of a Zintl-salt or intermetallic compounds as starting material and the specific metal-fluoro(hydro)carbon ligands used in the present invention makes it possible to obtain particles with a tailored emission spectrum, in particular an emission spectrum with a shift in the red direction as compared to blue quantum dots.

Fluoro(hydro)carbon-functionalized silicon quantum dots and their preparation has been described in the literature.

C. Qian et al. (J. Am. Chem. Soc. 2014, 136, 15849-15852) describes a method for grafting fluorohydrocarbon groups onto silicon nanoparticles, by a process in which hydride-terminated silicon nanocrystals are treated with 1H,1H,2H-perfluoro-1-decene in a two-phase solvent system, wherein the first solvent is n-decane and the second solvent is 1H,2H,2H-perfluoro-1-decene. The two solvents do not mix. The reaction is carried out in a closed vial for three hours at a temperature of 170° C., which is above the boiling point of the 1H,1H,2H-perfluoro-1-decene. The reaction was extended to 24 hours to increase the surface coverage. This reference does not describe ligands used in the present invention or the change in the emission spectrum obtained therewith.

T. K. Purkait (J. Am. Chem. Soc. 2016, 138, 7114-7120) describes grafting various types of groups onto the surface of silicon quantum dots. More specifically, alkoxy-terminated silicon quantum dots were obtained by reacting hydride-terminated quantum dots with aliphatic ketones by a process comprising the steps of combining the ketone of choice with a dispersion of silicon quantum dots in toluene solvent and allowing the mixture to react at 180° C. in a microwave chamber for one hour. Silicon quantum dots functionalized with aromatic ketones were obtained by an analogous process. 2-butoxy-terminated silicon quantum dots prepared by the method described above were used as starting material for the manufacture of alkyl/alkenyl substituted silicon quantum dots by combining an alkene starting material with a solution of 2-butoxy-terminated silicon quantum dots in THF. BH3.THF was added and the mixture was reacted for 1 hour at 150° C. 1H,2H,2H-perfluoro-1-hexene was used as starting material for the manufacture of fluorohydrocarbon-substituted silicon quantum dots. This reference does not describe ligands used in the present invention or the change in the emission spectrum obtained therewith.

The Purkait reference further requires the intermediate manufacture of 2-butoxy-terminated silicon quantum dots, which is an additional step.

L. A. Aslanov et al. (Russian Journal of Coordination Chemistry, 2013, Vol. 39, No. 6, 427-431) describes silicon nanocrystals with perfluorobutyl ligands. The particles are prepared from SiBr4 in the presence of 1,2-dimethoxyethane and potassium metal, resulting in the formation of bromine-terminated silicon quantum dots. The bromine-terminated quantum dots are then reacted with perfluorobutyllithium, which was prepared from perfluorobutyliodide and lithium amalgam. This reference makes use of silicon quantum dots prepared from SiBr4, which have been found to be sensitive to the incorporation of oxygen, resulting in an unpredictable change in colour. Additionally, the use of potassium described in this document is undesirable for a HSE perspective.

The method of the present invention makes it possible to obtain (per)fluoro(hydro)carbon-functionalized quantum dots with good optoelectronic properties, including a tailored emission spectrum in high quality in a stable manner. Further advantages of the method according to the invention and specific embodiments thereof will become apparent from the further specification.

The method will be discussed in more detail below.

The method according to the invention starts from a Zintl salt or intermetallic compound of post-transition metals or metalloids of silicon or germanium. Zintl salts are intermetallic compounds of group 1 or 2 metals.

Examples of suitable silicon compounds are Mg2Si, NaSi, KSi, CoSi2, B4Si, W5Si3, VSi2, CeSi2, Yb3Si5, IrSi, ZrSi2, Cu5Si, YSi2, Ni2Si, YbSi2, NbSi2, EuSi2, GeSi, SrSi2, ErSi2, PtSi, PdSi, NdSi2, BaSi2, MnSi2, CrSi2, WSi2, MoSi2, ZrSi2, Cr3Si, Mo5Si3.

For reasons of activity, availability and the absence of toxic heavy metals, the following silicon compounds are considered preferred: Mg2Si, NaSi, KSi, and Ca2Si.

Examples of suitable germanium compounds are Mg2Ge, NaGe, KGe, Ca2Ge, CuGe, GeTe, and CuGeSe.

For reasons of activity, availability and the absence of toxic heavy metals, the following germanium compounds are considered preferred: Mg2Ge, NaGe, KGe, and Ca2Ge.

Silicon quantum dots are more attractive than germanium quantum dots as silicon has wider availability and fewer toxicity issues. Therefor the use of silicon Zintl salts is considered preferred.

The silicon or germanium Zintl salt or intermetallic compound is reacted with a halogen-containing oxidizing agent to form halide-terminated silicon quantum dots.

Suitable halogen-containing oxidizing agents include Cl2, Br2, F2, and I2. The use of bromine as oxidizing agent is considered preferred, because it has been found to give it gives a high product yield and is practical to work with.

The Zintl salt or intermetallic compound and the oxidizing agent are brought together and allowed to react. The reaction between the Zintl salt or intermetallic compound and the oxidizing agent generally takes place in the presence of a solvent. Suitable solvents will be inert under reaction conditions in that they do not react with the Zintl salt or intermetallic compound or the oxidizing agent. Suitable solvents include organic solvents such as straight chain or branched alkanes with 4 to 18 carbon atoms, ethers, including mono-, di-, and polyethers with 4-18 carbon atoms, and fluorinated alkane compounds.

Straight chain or branched alkanes with 4 to 18 carbon atoms, in particular 6 to 12 carbon atoms have been found attractive in the method according to the invention, because they are inert under reaction conditions and are easy to work with.

Examples of preferred compounds are n-heptane, and n-octane. Ethers, including mono-, di-, and polyethers with 4-18 carbon atoms have also been found suitable. The use of di- and polyethers with 4-10 carbon atoms, such as 1,2-dimethoxyethane and 1-methoxy-2-(2-methoxyethoxy)ethane) has been found to be particularly attractive. Mixtures of different solvents may also be used. It is noted that while the halogen-containing oxidizing compound generally has a good solubility in the solvent, the solubility of the Zintl salt or intermetallic compound may be relatively low. It is not necessary for the Zintl salt or intermetallic compound to actually dissolve in the solvent. This may be preferred, however, to increase the reaction rate.

The reaction mixture comprising Zintl salt or intermetallic compound and oxidizing agent is allowed to react. Suitable reaction temperatures include 0 to 200° C., in particular room temperature to 150° C. A temperature below 0° C. is generally not attractive for industrial operation. A temperature above 200° C. is generally not attractive because it may require relatively high pressures.

The reaction pressure is not critical, as long as the various reactants are maintained in the liquid phase. A suitable pressure will thus depend on the reaction temperature. A pressure of 1-10 bar will generally be suitable, with atmospheric pressure being preferred.

The reaction time will generally vary between 2 hours and 7 days, with lower reaction temperatures necessitating longer reaction times. Longer reaction times at lower temperatures may result in lesser side products and higher yields.

Therefore, a reaction time of 24 hours to 7 days, in particular 24 hours to 5 days may be preferred. It may be preferred to combine a time in this range with a temperature in the range of range of 0-150° C.

The molar ratio between the oxidizing agent and the Zintl salt or intermetallic compound generally is in the range of 1:1 to 40:1. Outside these ranges there will either be insufficient oxidizing agent to obtain attractive conversion, or an unnecessary excess of oxidizing agent. It may be preferred for the molar ratio between the oxidizing agent and the Zintl salt or intermetallic compound to be in the range of 5:1 to 30:1, in particular 5:1 to 20:1.

The solvent generally makes up between 10 and 99 wt. % of the reaction mixture comprising Zintl salt or intermetallic compound, oxidizing agent and solvent. If the amount of solvent is below 10 wt. %, it is generally insufficient to allow proper mixing of the various reactants.

The reaction is carried out in an inert atmosphere. In particular, the presence of oxygen and water is to be avoided. Working in an inert atmosphere is within the scope of the person skilled in the art, and encompasses, e.g., the use of nitrogen blankets etc. This requires no further elucidation here.

Upon completion of the reaction, a dispersion of solid halide-terminated silicon quantum dots in a solvent will have been formed. This mixture can be used directly as starting material for the alkylation step. It is also possible to first isolate the quantum dots from the solvent by evaporation of the solvent and other low-boiling components.

It has been found that, as compared to other preparation methods, the manufacture of halide-terminated silicon or germanium quantum dots by reacting a Zintl salt or intermetallic compound of post-transition metals or metalloids of silicon or germanium with a halogen-containing oxidizing agent makes it possible to obtain halide-terminated silicon or germanium quantum dots with good properties, in particular a low level of oxygen contaminants. This results in the formation of halide-terminated silicon or germanium quantum dots and fluoro(hydro)carbon-substituted silicon or germanium quantum dots with good properties and, in the final particles, a desirable emission spectrum.

In the alkylation step, the halide-terminated silicon or germanium quantum dots are with a fluoro(hydro)carbon agent to form fluoro(hydro)carbon-substituted silicon or germanium quantum dots.

The fluoro(hydro)carbon agent is selected from the group of metal-fluoro(hydro)carbon compounds of the formula MR_{q}, wherein M is a metal selected from Group 1, 2, 4, 11, 12, 13, or 14 of the periodic table of elements, q is an integer which corresponds to the valence of the metal, and R is CFnHm-fluoro/hydro-carbon, wherein n is 1 or 2, m is 0 or 1, and the total of n and m is 2, wherein each R may be the same or different,

metal-fluoro(hydro)carbon halide compounds of the formula NQₐRₚ wherein N is a metal selected from Group 1, 2, 4, 11, 12, 13, or 14 of the periodic table of elements, Q is a halogen selected from F, Cl, Br, or I, wherein each Q may be the same or different, a and p are integers in the range of 1-3, and the total of a and p corresponds to the valence of the metal, and R is as defined above, and
metal-fluoro(hydro)carbon compounds of the formula CuR₂Li, wherein R is as defined above,
to form fluoro(hydro)carbon-substituted silicon or germanium quantum dots.

The fluoro(hydro)carbon group comprises an R group which is —CFₙHₘ-fluoro/hydro-carbon, wherein n is 1 or 2, m is 0 or 1, and the total of n and m is 2. A key element of this group is the CFnHm structure, which will be corrected to the silicon or germanium of the quantum dot. In the present invention the carbon atom connected to the quantum dot thus is substituted with one or two fluoro-atoms. It has been found that the presence of one or two fluoro-atoms at the carbon atom connected to the quantum dot is essential for obtaining the desired emission spectrum.

The fluoro(hydro)carbon group in R may be an alkylgroup, alkylarylgroup, arylgroup or arylalkyl group. The group generally has 1-20 carbon atoms. To achieve the effect of the present invention, longer chains may be preferred, e.g., at least 3 carbon atoms, or at least 5 carbon atoms. However, very long chains may not provide additional benefit, while they will complicate the synthesis process. Therefore, it may be preferred for the number of carbon atoms to be at most 12, in particular at most 10.

The use of alkyl-groups may be preferred. While the alkyl group may be straight-chained or branched, the use of straight-chained compounds is considered preferred because they form a less complicated structure on the surface.

The fluoro/hydro-carbon group in R may be a perfluoro group, a perhydro group, or a group comprising both fluoro and hydrogen substituents. Various embodiments of R thus include —CHF-perfluorocarbon, CHF-perhydrocarbon, CHF-fluorohydrocarbon, —CF2-perfluorocarbon, C2F-perhydrocarbon, and C2F-fluorohydrocarbon.

The use of a perfluorohydrocarbon group may be preferred because it is believed that this will lead to attractive optoelectronic properties. In this embodiment it is preferred for n to be 2 and m to be 0, resulting in R being —CF2-perfluorocarbon, with the perfluorohydrocarbon preferably being alkyl with 3-20 carbon atoms, more preferably 3-10 carbon atoms.

In one embodiment, the alkylating agent is a metal-fluoro(hydro)carbon compound of the formula MR_{q}, wherein M is a metal selected from group 1, 2, 4, 11, 12, 13, or 14 of the periodic table of elements. For group 1 the use of lithium, sodium or potassium may be preferred. For group 2 magnesium may be preferred. For group 4 zirconium or hafnium may be preferred. For group 11 copper may be preferred. For group 12 zinc may be preferred, for group 13 boron, aluminium, gallium, and indium may be preferred. For group 14 germanium, and lead may be preferred. Overall, lithium is considered preferred, because it is believed to yield better surface passivation and higher quantum yields. Accordingly, in one embodiment an n-perfluoroalkyl lithium of the formula LiCnF2n+1 wherein n is 1-20, preferably 4-12, is used.

In another embodiment a metal-fluoro(hydro)carbon halide compound of the formula NQₐRₚ is used wherein N is a metal selected from Group 1, 2, 4, 11, 12, 13, or 14 of the periodic table of elements, Q is a halogen selected from F, Cl, Br, or I, wherein each Q may be the same or different, a and p are integers in the range of 1-3, and the total of a and p corresponds to the valence of the metal.

For the metal N and the group R, the same preferences apply as for the metal M discussed above. The halogen Q may be selected from F, Cl, Br, and I. Br and Cl may be preferred

Examples of suitable compounds include fluoro(hydro)carbon magnesium halide, fluoro(hydro)carbon calcium halide, fluoro(hydro)carbon aluminium halide, fluoro(hydro)carbon zinc halide, fluoro(hydro)carbon gallium halide,

fluoro(hydro)carbon germanium halide, and fluoro(hydro)carbon indium halide. The use of fluoro(hydro)carbon magnesium bromide may be preferred in this group, as it has been found easy to work with, but other compounds are also suitable.

In one embodiment an n-perfluoroalkyl magnesium bromide of the formula BrMgCₙF₂ₙ₊₁ wherein n is 1-20, preferably 4-12 is used.

Where the metal-fluoro(hydro)carbon compound is of the formula CuR₂Li, wherein R is as defined above, the preferences for R expressed above also apply here.

The use of metal-fluoro(hydro)carbonhalide compounds may be preferred over the use of metal-perfluoro(hydro)carbon compounds, because the halide compounds may be easier to prepare. It is noted that the Aslanov reference discussed above uses a mercury-lithium amalgam in order to make the alkyl lithium compounds, which is highly toxic and very polluting.

To react the halide-terminated quantum dots with the fluoro(hydro)carbon agent the two compounds have to be brought into contact. An effective way to achieve this is to combine both compounds in a solvent. Suitable solvents for this step are the same solvents described above for the reaction between the Zintl salt or intermetallic compound and the oxidizing agent. The preferences given above also apply here. The solvent used in the fluoroalkylation step can be the same or different as the solvent used in the oxidation step of the Zintl salt or intermetallic compound.

The reaction mixture comprising halide-terminated silicon quantum dots and fluoro-alkylating agent is allowed to react. Suitable reaction temperatures include 0 to 200° C., in particular room temperature to 150° C. A temperature below 0° C. is generally not attractive for industrial operation. A temperature above 200° C. is generally not attractive because it may require relatively high pressures.

The reaction pressure is not critical, as long as the various reactants are maintained in the liquid phase. A suitable pressure will thus depend on the reaction temperature. A pressure of 1-10 bar will generally be suitable, while atmospheric pressure may be preferred.

The reaction time will generally vary between 10 minutes and 24 hours, with lower reaction temperatures necessitating longer reaction times. A reaction time of 10 minutes to 6 hours, in particular 3 hours may be preferred.

The amount of fluoro-alkylating agent is generally in excess of the amount required to react with the halide groups at the surface of the particles. It is within the scope of the skilled person to select a suitable amount.

The solvent generally makes up between 10 and 99 wt. % of the reaction mixture comprising halide-terminated quantum dots, fluoro(hydro)carbon agent and solvent. If the amount of solvent is below 10 wt. %, it is generally insufficient to allow proper mixing of the various reactants.

In particular, the presence of oxygen and water is to be avoided. Working in an inert atmosphere is within the scope of the person skilled in the art, and encompasses, e.g., the use of nitrogen blankets etc. This requires no further elucidation here.

Upon completion of the reaction, a dispersion of fluoro(hydro)carbon-substituted quantum dots in the solvent is obtained. The quantum dots can be isolated by evaporation of the solvent. If necessary, excess alkylating agent can be removed, e.g., by reaction with an alcohol.

The quantum dots can be purified by methods known in the art, e.g., washing with suitable solvents, extraction, e.g., using water/ethyl acetate, and chromatography, e.g., silica column chromatography using , e.g., ethyl acetate/heptane as eluent.

The invention makes it possible to obtain silicon or germanium quantum dots derived from a Zintl salt or intermetallic compound of post-transition metals or metalloids of silicon or germanium comprising CFnHm-fluoro/hydrocarbon groups bonded directly to the silicon or germanium of the particle.

That the particles are derived from a Zintl salt or intermetallic compound of post-transition metals or metalloids of silicon or germanium can be seen from the contaminant profile of the particles, in particular the presence of residual traces of metals from the Zintl salt or intermetallic compound.

The preferences expressed above for the Zintl salt or intermetallic compound of post-transition metals or metalloids of silicon or germanium and for the CFnHm-fluoro/hydrocarbon groups in the context of the preparation of the particles also apply here.

In one embodiment, the fluoro(hydro)carbon-substituted quantum dots that can be obtained by the method according to the invention have a number average particle size of 0.5-5 nm as determined by transmission electron microscopy.

In one embodiment, the fluoro(hydro)carbon-substituted quantum dots have a number average particle size of 2.2+/−0.5 nm as determined by transmission electron microscopy.

The present invention makes it possible to obtain perfluorocarbon substituted quantum dots which (after purification to remove excess alkylating agent etc) have a quantum yield of at least 1%, in particular at least 5%, more in particular at least 8%, in some embodiments at least 11%. Quantum yield can be determined through measurements in an integration sphere setup, or through relative quantum yield measurements.

In one embodiment, the particles are characterized by absorption ranging from UV (<200 nm) to (infra)red (>800 nm), though most strongly in the rang from UV to 400 nm).

In one embodiment, the particles of the present invention show an emission spectrum which shows a red-shift of 20-100 nm as compared to the same particles substituted with perhydroalkyl ligands.

In one embodiment of the present invention, the particles show an emission spectrum with a peak in the range of 495-570 nm. In the present specification UV and fluorescence emission spectra are determined at a quantum dot concentration of 0.01 g/l in ethyl acetate (>99% reagent grade).

19F NMR spectroscopy displays relatively broad signals corresponding to silicon bound perfluoroalkyl chains at chemical shifts in the −50 to −130 ppm range.

As will be evident to the skilled person, various preferred embodiments of the present invention as described above can be combined unless they are mutually exclusive.

The present invention will be elucidated by the following example, without being limited thereto or thereby.

### EXAMPLE 1: PREPARATION OF SUBSTITUTED SILICON QUANTUM DOTS

First, Mg₂Si (0.5 g, 6.5 mmol) was added into n-octane (500 mL). Vacuum degassing under nitrogen filling cycles were performed three times to remove any oxygen from the reaction system. Then Br₂ (2.7 mL, 52 mmol) was added under N₂ atmosphere under continuous stirring. The suspension was stirred at 130° C. for 3 days. When the reaction was completed, the suspension was kept under N₂, while solvents were removed by distillation. To the flask fresh N₂-bubbled n-octane (500 mL) was added, and the obtained halide terminated Si QD suspension was cooled on ice. Then perfluorohexylmagnesium bromide was added to the above suspension. The reaction mixture was stirred overnight, and MeOH was added dropwise to quench any excess Grignard reagents. The mixture was stirred for 1 h. The mixture was filtered and the filtrate was subsequently extracted with aqueous HCl (1M) (1×) and distilled water (3×), and finally the organic fractions were dried over Na2SO4. Solvent was removed under reduced pressure, yielding ˜134 mg Si quantum dots as a dark red solid. The quantum yields of crude products are approximately 1%. Subsequent purification via column chromatography typically yields products with increased quantum yields of 5-6%.

The particles had a particle size of 2.2 nm+/−0.5 nm, as determined via TEM.

They showed absorption ranging from UV (<200 nm) to (infra)red (>800 nm), though most strongly in the range from UV to 400 nm). The emission maximum was at 525-530 nm.

19F NMR spectroscopy displayed relatively broad signals corresponding to silicon bound perfluoroalkyl chains at chemical shifts in the −65 to −70 ppm range, −80 to −90 ppm range and −115 to −130 ppm range.

### EXAMPLE 2: COMPARISON OF EMISSION OF ALKYL-SUBSTITUTED SILICON QUANTUM DOTS AND PERFLUOROALKYL SUBSTITUTED QUANTUM DOTS

Particles substituted with per-hydroalkyl groups were prepared as described in Dohnalová, K.; Poddubny, A. N.; Prokofiev, A. A.; de Boer, W. D.; Umesh, C. P.; Paulusse, J. M. J.; Zuilhof, H.; Gregorkiewicz, T. Light Sci. Appl. 2013, 2 (1), e47.

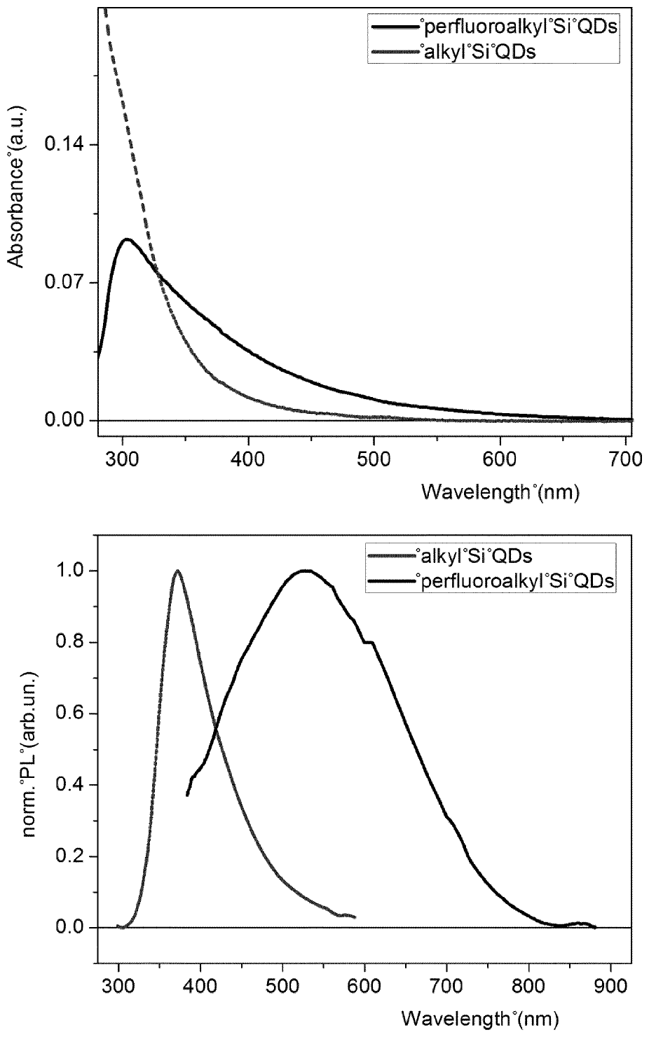

FIG. 1 provides the emission spectra of the per-fluoro-alkyl substituted particles of example 1 and of the per-hydro-alkyl substituted particles of Dohnalova et al. As can be seen from the FIGURE, the perfluoro-alkyl substituted quantum dots show a peak in the emission spectrum in the range of 495-570 nm, while the alkyl-substituted quantum dots show a peak at lower wavelengths in the range of 410-460 nm. Expressed otherwise, the emission of the per-fluoro-alkyl substituted particles shows a red-shift of about 20-80 nm.

1. A method for manufacturing fluoro(hydro)carbon-substituted silicon or germanium quantum dots which comprises the steps of:
reacting a Zintl salt or intermetallic compound of post-transition metals or metalloids of silicon or germanium with a halogen-containing oxidizing agent to form halide-terminated silicon or germanium quantum dots,
reacting the halide-terminated silicon or germanium quantum dots with a fluoro(hydro)carbon agent selected from the group consisting of:
metal-fluoro(hydro)carbon compounds of the formula MR_{q}, wherein M is a metal selected from Group 1, 2, 4, 11, 12, 13, or 14 of the periodic table of elements, q is an integer which corresponds to the valence of the metal, and R is CFnHM-gluoro/hydrocarbon, wherein n is 1 or 2, m is 0 or 1, and the total of n and m is 2, and wherein each R may be the same or different,
metal-fluoro(hydro)carbon halide compounds of the formula NQₐRₚ wherein N is a metal selected from Group 1, 2, 4, 11, 12, 13, or 14 of the periodic table of elements, Q is a halogen selected from F, Cl, Br, or I, wherein each Q may be the same or different, a and p are integers in a range of 1-3, a total of a and p corresponds to the valence of the metal, and R is as defined above, and
metal-fluoro(hydro)carbon compounds of the formula CuR₂Li, wherein R is as defined above,
to form fluoro(hydro)carbon-substituted silicon or germanium quantum dots.

2. The method according to claim 1, wherein the Zintl salt or intermetallic compound of post-transition metals or metalloids of silicon or germanium is selected from the group consisting of Mg₂Si, NaSi, KSi, Ca2Si, Mg₂Ge, NaGe, KGe, and Ca₂Ge.

3. The method according to claim 1, wherein the Zintl salt is a silicon Zintl salt.

4. The method according to claim 1, wherein the halogen-containing oxidizing agent is selected from the group consisting of Cl₂, Br₂, F₂, I₂, and mixtures thereof.

5. The method according to claim 1, wherein R has at least 3 carbon atoms and/or at most 16 carbon atoms.

6. The method according to claim 1, wherein R is an alkyl group.

7. The method according to claim 1, wherein the fluoro(hydro)carbon agent is selected from the group consisting of n-perfluoroalkyl lithium of the formula LiCₙF₂ₙ₊₁, wherein n is 1-20, and n-perfluoroalkyl magnesium bromide of the formula BrMgCₙF₂ₙ₊₁ wherein n is 1-20.

8. Silicon or germanium quantum dots derived from a Zintl salt or intermetallic compound of post-transition metals or metalloids of silicon or germanium comprising CFnHm-fluoro/hydrocarbon groups bonded directly to the silicon or germanium of the particle.

9. The quantum dots according to claim 8, having a number average particle size of 0.5-5 nm, as determined by transmission electron microscopy.

10. The quantum dots according to claim 9, having a number average particle size of 2.2+/−0.5 nm, as determined by transmission electron microscopy.

11. The quantum dots according to claim 8, having a quantum yield of at least 1%.

12. The quantum dots according to claim 8, having an emission spectrum which shows a red-shift of 20-100 nm, as compared to the same particles substituted with perhydroalkyl ligands.

13. The quantum dots according to claim 8, having an emission spectrum with a peak in a range of 495-570 nm.

14. The method according to claim 3, wherein the Zintl salt is a silicon Zintl salt selected from the group consisting of Mg₂Si, NaSi, KSi and Ca₂Si.

15. The method according to claim 4, wherein the halogen-containing oxidizing agent is Br₂.

16. The method according to claim 5, wherein R has at least 5 carbon atoms, and/or at most 11 carbon atoms.

17. The method according to claim 6, wherein R is a straight-chain alkyl group.

18. The method according to claim 7, wherein the fluoro(hydro)carbon agent is selected from the group consisting of n-perfluoroalkyl lithium of the formula LiCₙF₂ₙ₊₁, wherein n is 4-12, and n-perfluoroalkyl magnesium bromide of the formula BrMgCₙF₂₊₁ wherein n is 4-12.

19. The quantum dots according to claim 8, having a quantum yield of at least 5%.

20. The quantum dots according to claim 8, having a quantum yield of at least 11%.
